(19) United States
(12) Patent Application Publication
(10) Pub. No.: US 2025/0266486 A1
(43) Pub. Date: Aug. 21, 2025

(54) CELL SUPPLY DEVICE FOR SECONDARY BATTERY

(71) Applicant: SE CO.,LTD., Hwaseong-si (KR)

(72) Inventor: Yong Hyun KANG, Anyang-si (KR)

(73) Assignee: SE CO.,LTD., Hwaseong-si (KR)

(21) Appl. No.: 18/589,383

(22) Filed: Feb. 27, 2024

(30) Foreign Application Priority Data
Feb. 20, 2024 (KR) 10-2024-0023959

(51) Int. Cl. H01M 10/04

(52) U.S. Cl. CPC H01M 10/0409

(57) ABSTRACT

A cell supply device for a secondary battery includes a base plate on which first to third turntables, a positive electrode material tray, and a negative electrode material tray are installed, a cell elevating unit installed on an upper surface of the first turntable to move up and down, a cell supply member on which a cell adsorption unit configured to adsorb cells is installed, a first transport member provided with the second turntable installed at one side of the cell supply member, a cell transport tray on which the cells are stacked, and a slider unit installed on a lower surface of the cell transport tray, and a second transport member in which the cell elevating unit and the cell adsorption unit (151) are installed on the third turntable.

### CROSS-REFERENCE TO RELATED APPLICATION

This application claims priority to and the benefit of Korean Patent Application No. 10-2024-0023959, filed on Feb. 20, 2024, the disclosure of which is incorporated herein by reference in its entirety.

### BACKGROUND

### 1. Field of the Invention

The present invention relates to a cell supply device for a secondary battery, and more specifically, to a cell supply device for a secondary battery, which supplies cells to be stacked on a stacking unit by consecutively moving the cells one by one while rotating a plurality of turntables.

### 2. Discussion of Related Art

In general, a chemical battery is a battery including negative and positive electrode plates facing each other, a separator (membrane) located between the negative and positive electrode plates, and an electrolyte, and the capacity of storable energy is changed depending on materials forming the electrode plates and the electrolyte.

Such chemical batteries are classified into primary batteries, which have very slow charging reaction and are used only for one-time discharging, and secondary batteries, which may be reused through repeated charging and discharging, and recently, the use of the secondary batteries tends to be rapidly increased due to an advantage in that the secondary batteries are chargeable and dischargeable.

Due to the advantage, the secondary batteries are applied to various technical fields throughout the industry, and as an example, are widely used as energy sources for advanced electronic devices such as wireless mobile devices and are also attracting attention as energy sources for electric vehicles, which are being suggested as measures for solving problems of air pollution of conventional gasoline and diesel internal combustion engines using fossil fuels and the exhaustion of fossil fuels.

The secondary battery is configured in a form in which a positive electrode plate, a separator (membrane), and a negative electrode plate are sequentially stacked and immersed in an electrolyte solution, and there are two major methods for manufacturing a cell stack inside the secondary battery.

There are a first method of sequentially overlapping and then winding a negative electrode plate, a separator, a positive electrode plate, and a separator together to form a jelly-roll form and a second method of cutting the negative electrode plate and the positive electrode plate to required sizes and alternately stacking the negative electrode plate, the separator, the positive electrode plate, and the separator.

To manufacture high-capacity or large-sized secondary batteries, the second stacking method is advantageous in terms of battery lifetime and space efficiency and thus is increasingly adopted to electric vehicles.

There are several methods of manufacturing an internal cell (assembly of electrodes and separators) of the secondary battery using the stacking method.

FIG. 1 is a schematic view showing a cell stack inside a secondary battery manufactured by a Z-stacking method. FIG. 2 is a plan view showing a conventional apparatus for manufacturing a cell stack of a secondary battery using the Z-stacking method.

As shown in FIGS. 1 and 2, a method of folding a continuous separator 3 in a zigzag shape and alternately stacking a negative electrode plate 1 and a positive electrode plate 2 between the folded separator is referred to as Z-folding & stacking or Z-stacking for short.

As disclosed in Korean Patent No. 10-1140447, as an apparatus for manufacturing an internal cell of a secondary battery using a Z-stack method as described above, cell manufacturing apparatuses in which an apparatus for stacking materials such as electrode plates and separators and an apparatus for transporting electrode plates to stacking positions stack the materials while repeatedly performing linear reciprocating motion and vertical elevating motion have been most widely used in the past.

As shown in FIG. 2, in such Z-folding & stacking manufacturing apparatuses, a negative electrode plate 1 and a positive electrode plate 2 are stack on individual tables T spaced apart from each other in a left-right direction, a stage 4 on which the negative electrode plate 1 and the positive electrode plate 2 are disposed is installed to reciprocate horizontally between the individual tables T, and a robot 5 alternately picks up and transports the negative electrode plate 1 and the positive electrode plate 2 on the tables T to be stacked on a folded and unfolded separator 3 on the stage 4.

Since the conventional Z-stacking method requires much work time due to a long horizontal moving distance of the stage 4, a problem of degrading productivity has occurred.

In addition, when an operating speed of the apparatus is increased to shorten a working time, vibrations and noise rapidly increase, making it impossible to secure the positional accuracy of the apparatus, and since the stacked materials are shaken while the stage 4 repeats reciprocating and stopping, there has been a problem in that the stacking precision between the electrodes inside the cell is not secured.

FIG. 3 is a view showing a cell stack process implemented in the conventional apparatus for manufacturing the cell stack.

Recently, in manufacturing a Z-folding stacked secondary battery cell stack, as disclosed in Korean Patent No. 10-2120403, a swing type cell stack method of manufacturing a cell stack by performing laterally reciprocating swinging on a stack table at a predetermined angle and alternately supplying and stacking a negative electrode plate and a positive electrode plate on a separator stacked on the stack table at both sides of the stack table is being used.

However, upon using the swing-type cell stack method such as the apparatus for manufacturing the secondary battery cell of the above registered patent, since the stack table rotates while tilting to both sides at a predetermined angle, there is a problem in that a large tension is applied to the separator stacked on the stack table, thereby causing damage to the separator and degrading stack precision.

In other words, conventionally, as shown in FIG. 3, in a state in which a separator 3 is fixed on a stack table 10 by a plurality of clamp units 20, the stack table 10 receives a negative electrode plate or a positive electrode plate from a transport device 30 by laterally rotating at a predetermined angle, and since the stack table 10 is in a state of being tilted at a predetermined angle with respect to the ground when the stack table 10 receives the negative electrode plate or the positive electrode plate, a large tension can be applied to an end of the separator 3 caught on the clamp unit 20 to cause damage to the separator 3 or in a severe case, the separator 3 can be torn to cause defects or the stop of work, thereby significantly degrading productivity.

In addition, when the stack table 10 receives and stacks the negative electrode plate or the positive electrode plate in the state of being tilted at the predetermined angle, there is a problem in that instantaneous slipping occurs due to a load, making it difficult to keep constant stacking positions.

Since a cell supply device used in the conventional cell manufacturing apparatus is moved using a robot arm, it takes a long time to work, resulting in the degradation of productivity of cell manufacturing.

### RELATED ART DOCUMENTS

### Patent Documents

(Patent Document 1) Korean Patent No. 10-1140447 (Patent Document 2) Korean Patent No. 10-2120403

(Patent Document 3) Korean Patent Application Publication No. 10-2023-0135936

### SUMMARY OF THE INVENTION

The present invention is directed to providing a cell supply device for a secondary battery, which is capable of shortening a work time according to cell movement by consecutively supplying cells of a negative electrode material and positive electrode material stacked on a base plate by rotation of a turntable.

The present invention is also directed to providing a cell supply device for a secondary battery, which is capable of consecutively supplying cells without a delay time caused by a first transport member and a second transport member by alternately adsorbing the negative electrode material and the positive electrode material on a cell adsorption unit installed on the turntable.

According to an aspect of one embodiment of the present invention, there is provided a cell supply device for a secondary battery that includes a base plate (110) on which first to third turntables (131, 171, and 191) installed rotatably, a positive electrode material tray (111) on which a positive electrode material is stacked, and a negative electrode material tray (121) on which a negative electrode material is stacked are installed, a cell supply member (130) on which a cell elevating unit (135) installed on an upper surface of the first turntable (131) to move up and down so that cells (113) stacked on the positive electrode material tray (111) and the negative electrode material tray (112) are adsorbed, and a cell adsorption unit (151) configured to adsorb the cells (113) stacked on the positive electrode material tray (111) and the negative electrode material tray (112) by upward and downward movements of the cell elevating unit (135) are installed, a first transport unit (170) provided with a second turntable (171) installed at one side of the cell supply member (130), a cell transport tray (173) on which the cells (113) moved from the second turntable (171) are stacked, and a slider unit (175) installed on a lower surface of the cell transport tray (173) to adjust a position of the cell transport tray (173), and a second transport member (190) in which a cell elevating unit (135) and a cell adsorption unit (151) are installed on the third turntable (191) to move the cells (113) stacked on the cell transport tray (173) of the first transport cell (170) to a stack table.

The positive electrode material tray (111) on which the positive electrode material is stacked and the negative electrode material tray (112) on which the negative electrode material is stacked may be installed to be spaced a predetermined distance from each other on the base plate (110), the first turntable (131) may be installed to rotate horizontally at a predetermined height of the base plate (110), the second turntable (171) may be installed to rotate horizontally at a predetermined height of the base plate (110), and the third turntable (191) may be installed to rotate in a direction perpendicular to the base plate (110) to move the cells (113) stacked on the cell transport tray (173) of the second turntable (171).

A plurality of cell elevating units (135) may be radially installed on the first turntable (131) of the cell supply member (130) and the third turntable (191) of the second transport member (190) so that the cell adsorption unit (151) configured to adsorb the cells (113) may move up and down, and the cell adsorption unit (151) for adsorbing the cells (113) may be installed on the cell elevating unit (135) to move up and down.

In the cell elevating unit (135), an LM guide (136) and an LM cover (137) may be provided, and a slider block (138) may be installed inside the LM guide (136) and the LM cover (137) to be moved up and down by rotation of a motor (141) installed above the LM guide (136), a slider cover (144) may be installed on a front surface of the slider block (138), and a steel band (143) may be elastically installed between the slider block (138) and the slider cover (144) to block introduction of foreign substance into the LM guide (136), and in the cell adsorption unit (151), a vertical plate (152) may be installed on a front surface of the slider cover (144), a horizontal plate (154) may be installed on a lower surface of the vertical plate (152), a lower plate (155) may be installed on a lower surface of the horizontal plate (154), and an adsorption port (157) may be installed on a lower surface of the lower plate (155) to adsorb the cell (113).

The first transport member (170) may include the cell transport tray (173) radially installed on an upper surface of the second turntable (171) so that the cells (113) transported from the cell supply member (130) are stacked, and the slider unit (175) configured to adjust the cell transport tray (173) so that the cells (113) are placed on the cell transport tray (173) in a state of being aligned at a correct position.

### BRIEF DESCRIPTION OF THE DRAWINGS

FIG. 1 is a schematic view showing a cell stack inside a secondary battery manufactured by a Z-stacking method.

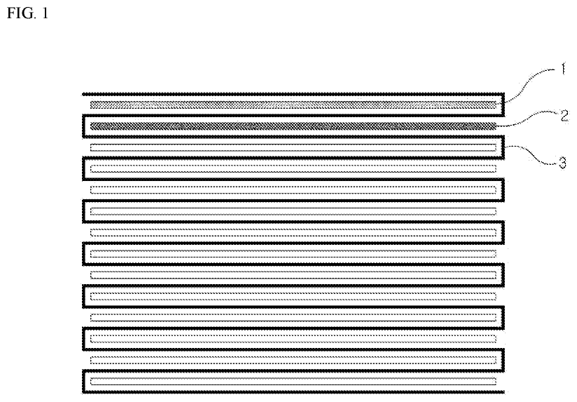

FIG. 2 is a plan view showing a conventional apparatus for manufacturing a cell stack of a secondary battery using the Z-stacking method.

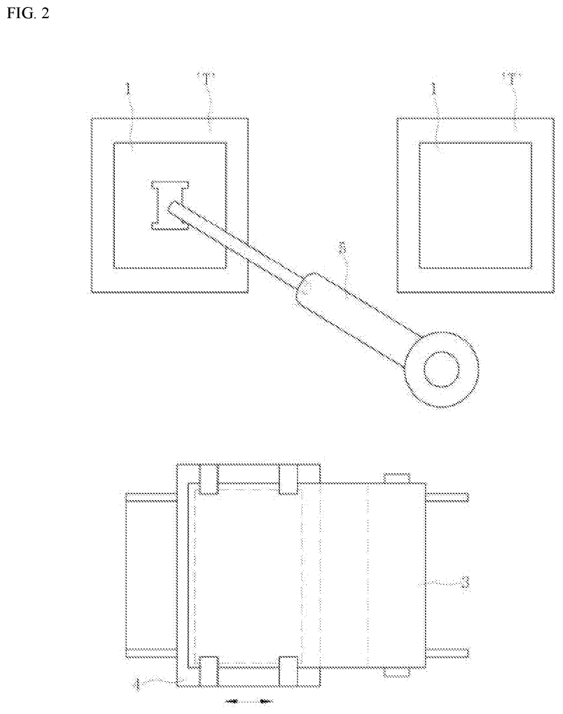

FIG. 3 is a view showing a cell stack process implemented in a conventional apparatus for manufacturing a cell stack.

FIG. 4 is a three-dimensional view showing a cell supply device for a secondary battery according to an exemplary embodiment of the present invention.

FIG. 5 is a three-dimensional view showing the cell supply device for a secondary battery according to the exemplary embodiment of the present invention.

FIG. 6 is a front view showing the cell supply device for a secondary battery according to the exemplary embodiment of the present invention.

FIG. 7 is a plan view showing the cell supply device for a secondary battery according to the exemplary embodiment of the present invention.

FIG. 8 is a three-dimensional view showing a cell supply member of the cell supply device for a secondary battery according to the exemplary embodiment of the present invention.

FIG. 9 is a three-dimensional view showing the cell supply member of the cell supply device for a secondary battery according to the exemplary embodiment of the present invention.

FIG. 10 is an exploded three-dimensional view showing the cell supply member of the cell supply device for a secondary battery according to the exemplary embodiment of the present invention.

FIG. 11 is an exploded three-dimensional view showing the cell supply member of the cell supply device for a secondary battery according to the exemplary embodiment of the present invention.

FIG. 12 is a three-dimensional view showing a slider unit of the cell supply device for a secondary battery according to the exemplary embodiment of the present invention.

FIG. 13 is an exploded three-dimensional view showing the slider unit of the cell supply device for a secondary battery according to the exemplary embodiment of the present invention.

FIG. 14 is a three-dimensional view showing the cell supply device for a secondary battery according to the exemplary embodiment of the present invention.

### DETAILED DESCRIPTION OF THE INVENTION

Hereinafter, embodiments of the present invention will be described in detail with reference to the accompanying drawings so that those skilled in the art to which the present invention pertains may easily carry out the present invention.

However, since the description of the present invention is only an embodiment for structural and functional description, the scope of the present invention should not be construed as limited by embodiments described herein.

For example, since embodiments can be modified in various ways and can have various forms, it should be understood that the scope of the present invention includes equivalents capable of realizing the technical spirit.

In addition, since the objects or effects presented in the present invention do not mean that a specific embodiment should include all or only such effects, the scope of the present invention should not be understood as limited thereby.

In the specification, the present embodiments are provided to make the disclosure of the present invention complete and fully convey the scope of the invention to those skilled in the art to which the present invention pertains. In addition, the present invention is only defined by the scope of the claims.

Therefore, in some embodiments, well-known components, well-known operations, and well-known technologies are not specifically described to avoid ambiguous construction of the present invention.

Meanwhile, the meaning of the terms described in the present invention is not limited to the dictionary meaning and should be understood as follows.

Unless otherwise defined, all terms used herein have the same meaning as commonly understood by those skilled in the art to which the present invention pertains.

Terms defined in commonly used dictionaries should be construed as consistent with the meaning they have in the context of the related technology and cannot be construed as having an ideal or excessively formal meaning unless clearly defined in the present invention.

Hereinafter, a cell supply device for a secondary battery according to an exemplary embodiment of the present invention will be described in detail with reference to the accompanying drawings.

The cell supply device for a secondary battery according to the exemplary embodiment of the present invention includes first to third turntables 131, 171, and 191 installed rotatably, a base plate 110 on which a positive electrode material tray 111 on which a positive electrode material is stacked and a negative electrode material tray 112 on which a negative electrode material is stacked are installed, a cell elevating unit 135 installed on an upper surface of the first turntable 131 to move up and down so that a cell stacked on the positive electrode material tray 111 and the negative electrode material tray 112 are adsorbed, a cell supply member 130 on which a cell adsorption unit 151 for adsorbing the cells 113 stacked on the positive electrode material tray 111 and the negative electrode material tray 112 by the upward and downward movements of the cell elevating unit 135 is installed, installed at one side of the cell supply member 130, a cell transport tray 173 on which the cell 113 moved from the second turntable 171 is stacked, a first transport member 170 provided with a slider unit 175 installed on a lower surface of the cell transport tray 173 to adjust a position of the cell transport tray 173, and a second transport member 190 on which the cell elevating unit 135 and the cell adsorption unit 151 are installed on the third turntable 191 to move the cell 113 stacked on the cell transport tray 173 of the first transport member 170 to a stack table.

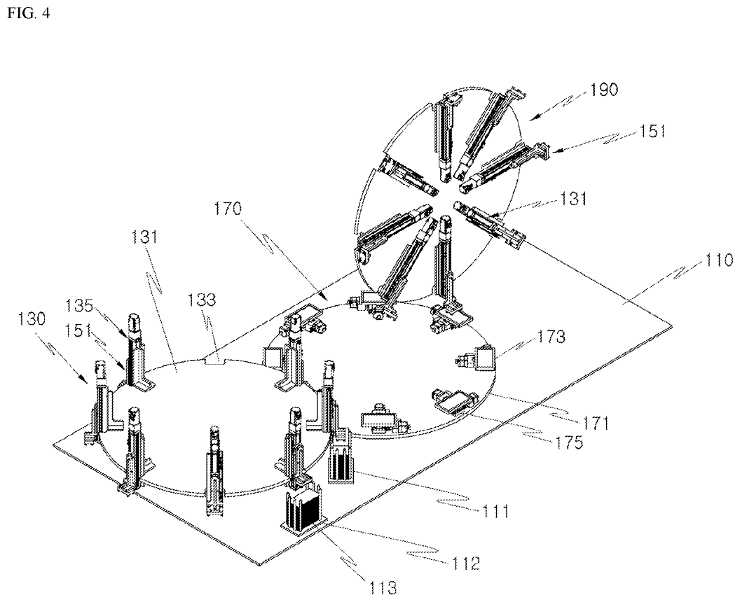

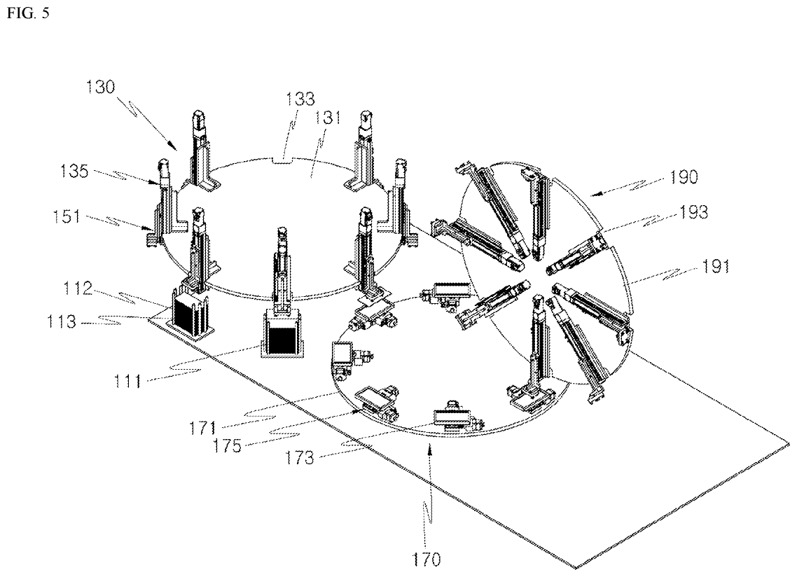

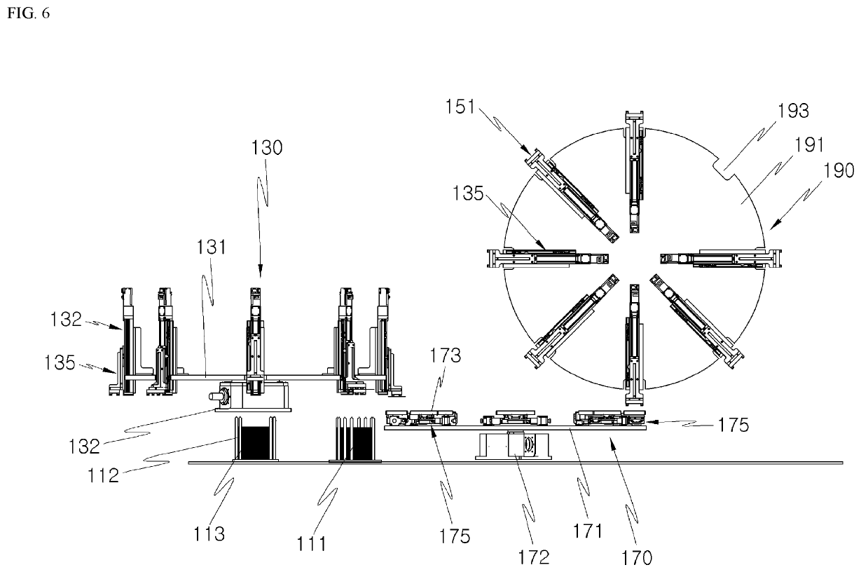

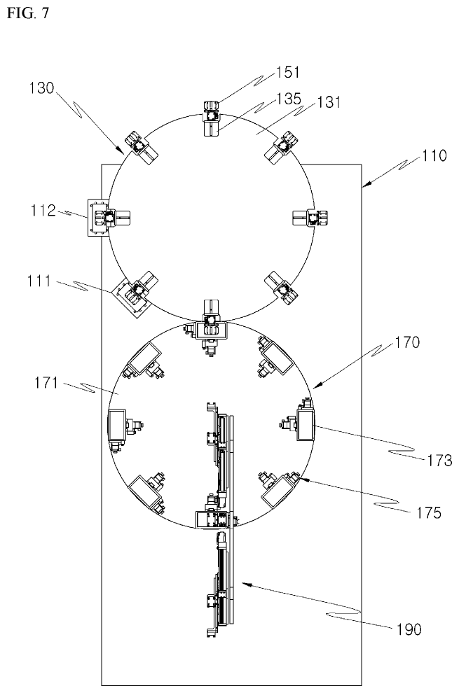

FIG. 4 is a three-dimensional view showing a cell supply device for a secondary battery according to an exemplary embodiment of the present invention, FIG. 5 is a three-dimensional view showing the cell supply device for a secondary battery according to the exemplary embodiment of the present invention, FIG. 6 is a front view showing the cell supply device for a secondary battery according to the exemplary embodiment of the present invention, and FIG. 7 is a plan view showing the cell supply device for a secondary battery according to the exemplary embodiment of the present invention.

As shown in FIGS. 4 to 7, the cell supply device of the present invention includes the base plate 110 on which the plurality of turntables 131, 171, and 191 are installed, the cell supply member 130 for moving the cells 113 stacked on the positive electrode material tray 111 and the negative electrode material tray 112 of the base plate 110 to the second turntable 171, the first transport member 170 for temporarily stacking the cells 113 moved from the cell supply member 130, and the second transport member 190 installed to rotate in a direction perpendicular to the first transport member 170.

On the base plate 110, the positive electrode material tray 111 on which the positive electrode material is stacked and the negative electrode material tray 112 on which the negative electrode material is stacked are installed to be spaced a predetermined distance from each other, the first turntable 131 is installed to rotate horizontally at a predetermined height of the base plate 110, the second turntable 171 is installed to rotate horizontally at a predetermined height of the base plate 110, and the third turntable 191 is rotatably installed in a direction perpendicular to the base plate 110 to move the cells 113 stacked on the cell transport tray 173 of the second turntable 171.

The base plate 110 is formed as a flat plate with a predetermined size, and on the base plate 110, the positive electrode material tray 111 on which the cell 113, which is a positive electrode material, is stacked, is installed, and the negative electrode material tray 112 on which the cell 113, which is a negative electrode material, is stacked is installed to be spaced a predetermined distance from the positive electrode material tray 111.

In other words, the cells 113 are stacked on each of the positive electrode material tray 111 and the negative electrode material tray 112 to a predetermined height.

In addition, on the base plate 110, the first turntable 131 for moving the cells 113 is installed to rotate horizontally, the second turntable 171 for temporarily stacking the cells 113 moved from the first turntable 131 is installed to rotate horizontally, and the third turntable 191 is installed to rotate in a vertical direction which is a direction perpendicular to the second turntable 171.

The first turntable 131 is installed higher than the second turntable 171. This allows a large amount of cells 113 to be stacked on the trays 111 and 112, thereby reducing the number of processes of stacking the cells 113 on the trays 111 and 112 and thus shortening the work time.

A plurality of cell elevating units 135 are radially installed on the first turntable 131 of the cell supply member 130 and the third turntable 191 of the second transport member 190 to allow the cell adsorption unit 151 for adsorbing the cells 113 to move up and down, and the cell adsorption unit 151 for adsorbing the cells 113 is installed on the cell elevating unit 135 to move up and down.

The cell supply member 130 moves the cells 113 stacked on the trays 111 and 112 to the first transport member 170, and the first transport member 170 rotates the cells 113 transported from the cell supply member 130 and supplies the cells 113 to the second transport member 190.

In addition, the second transport member 190 supplies the cells placed on the first transport member 170 to the stack table (not shown).

In other words, the cell supply member 130 moves the cells 113 of the trays 111 and 112 to the first transport member 170, the first transport member 170 rotates toward the second transport member 190, and the second transport member 190 supplies the cells 113 to the stack table.

A plurality of cell elevating units 135 moving up and down so that the cells 113 are adsorbed and a plurality of cell adsorption units 151 for adsorbing the cells 113 are radially installed on the first turntable 131 and the third turntable 193 in the cell supply member 130 and the second transport member 190.

The cell elevating unit 135 and the cell adsorption unit 151 installed on the cell supply member 130 and the second transport member 190 are the same, and thus will be described using the same names and the same reference numerals.

A first rotation motor 132 is installed on a lower surface of the first turntable 131 of the cell supply member 130, and the first turntable 131 rotates at a constant speed.

A sliding groove portion 133 is formed in the first turntable 131 so that the cell elevating unit 135 may be installed radially.

Eight sliding groove portions 133 are formed in the first turntable 131, and it goes without saying that eight or more sliding groove portions 133 may be formed if necessary.

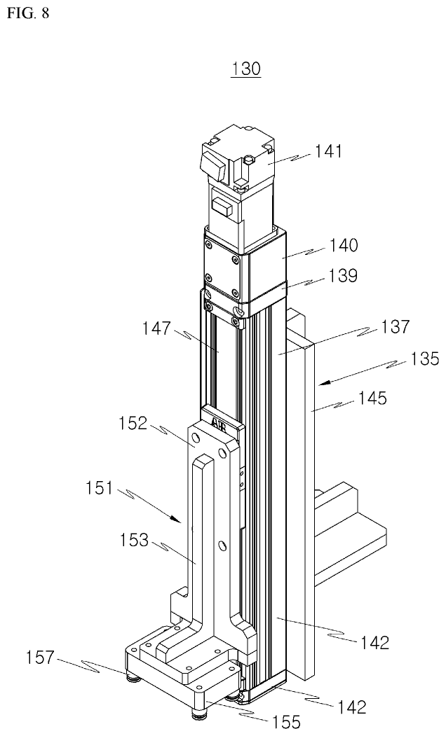

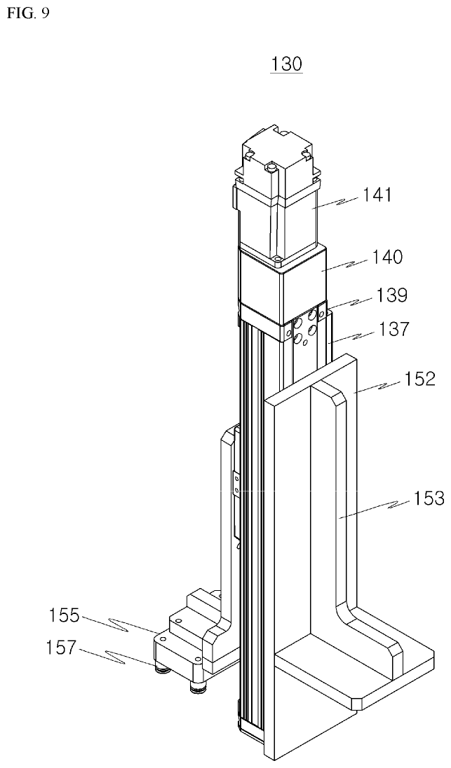

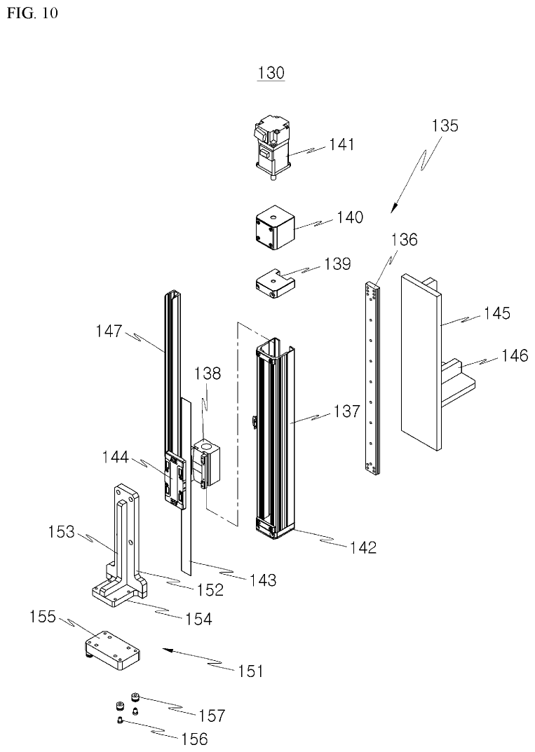

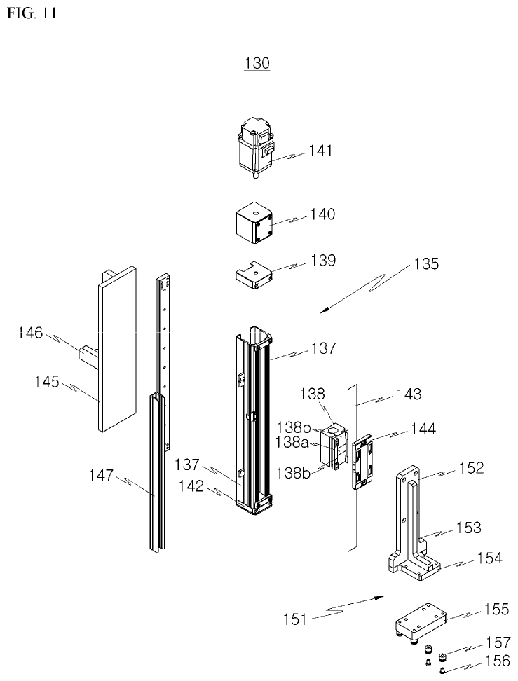

FIG. 8 is a three-dimensional view showing a cell supply member of the cell supply device for a secondary battery according to the exemplary embodiment of the present invention, FIG. 9 is a three-dimensional view showing the cell supply member of the cell supply device for a secondary battery according to the exemplary embodiment of the present invention, FIG. 10 is an exploded three-dimensional view showing the cell supply member of the cell supply device for a secondary battery according to the exemplary embodiment of the present invention, and FIG. 11 is an exploded three-dimensional view showing the cell supply member of the cell supply device for a secondary battery according to the exemplary embodiment of the present invention.

As shown in FIGS. 8 to 11, in the cell elevating unit 135, an LM guide 136 and an LM cover 137 are provided, a slider block 138 is installed inside the LM guide 136 and the LM cover 137 to be moved up and down by the rotation of a motor 141 installed above the LM guide 136, a slider cover 144 is installed on a front surface of the slider block 138, and a steel band 143 is elastically installed between the slider block 138 and the slider cover 144 to block the introduction of foreign substance into the LM guide 136, and in the cell adsorption unit 151, a vertical plate 152 is installed on a front surface of the slider cover 144, a horizontal plate 154 is installed on a lower surface of the vertical plate 152, a lower plate 155 is installed on a lower surface of the horizontal plate 154, and an adsorption port 157 is installed on a lower surface of the lower plate 155 to adsorb the cell 113.

The cell elevating unit 135 moves up and down the cell adsorption unit 151 installed thereunder, and the LM cover 137 is installed on a front surface of the LM guide 136.

A slider block 138 is installed inside the LM guide 136 and the LM cover 137 to move up and down, a support block 139 is installed on an upper surface of the LM cover 137, and a motor bracket 140 and a motor 141 are installed on an upper surface of the support block 139.

An end cover 142 is installed on a lower surface of the LM cover 137, and the steel band 143 for preventing the introduction of foreign substance into the LM guide 136 is installed on a front surface of the LM cover 137.

The slider cover 144 is installed on the front surface of the slider block 138, and the steel band 143 is elastically installed between the slider block 138 and the slider cover 144.

Meanwhile, a vertical surface 138a is formed on the front surface of the slider block 138 at a predetermined height, an inclined surface 138b inclined at a predetermined angle is formed above and under the vertical surface 138a, and the vertical surface 138a and the inclined surface 138b are formed to allow the steel band 143 to be easily deformed so that the slider block 138 smoothly moves up and down.

A fixing plate 145 is installed on a rear surface of the LM guide 136, a rear fixing angle 146 is installed on the fixing plate 145, and a sensor bracket 147 is installed so that a sensor (not shown) for detecting the upward and downward movements of the slider block 138 may be installed on a side surface of the LM cover 137.

In other words, the slider block 138 is moved up and down at an appropriate height by the sensor (not shown) installed on the sensor bracket 147.

The cell adsorption unit 151 for adsorbing the cell 113 while moved up and down by the slider block 138 is installed on the front surface of the LM cover 137.

The vertical plate 152 of the cell adsorption unit 151 is installed on the front surface of the slider cover 144, a front reinforcement angle 153 is installed on a front surface of the vertical plate 152, and the horizontal plate 154 is installed on a lower surface of the front reinforcement angle 153.

The lower plate 155 with a predetermined thickness is installed on the lower surface of the horizontal plate 154, and the adsorption port 157 is installed on the lower surface of the lower plate 155 by a fixing bolt 156.

The adsorption port 157 adsorbs the cell 113 while contracted by the upward and downward movements of the slider block 138.

In the cell supply member 130, the cell adsorption unit 151 is moved down by the plurality of cell elevating units 135 radially installed on the first turntable 131, and the cell adsorption unit 151 is moved up by the cell elevating unit 135 after adsorbing the cells 113 stacked on the trays 111 and 112.

In addition, since the plurality of cell elevating units 135 are radially installed on the cell supply member 130, the plurality of cell elevating units 135 adsorb and move the cell 113 stacked on the positive electrode material tray 111 and alternately adsorb the cells 113 stacked on the negative electrode material tray 112 to move the cells 113 to the first transport member 170.

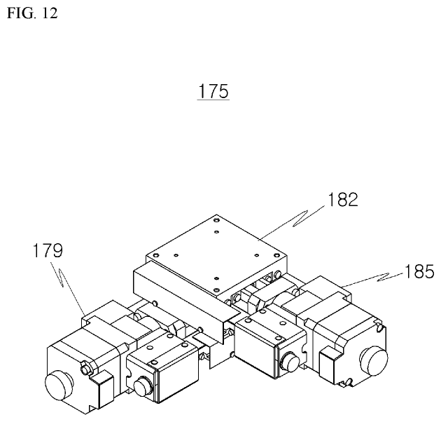

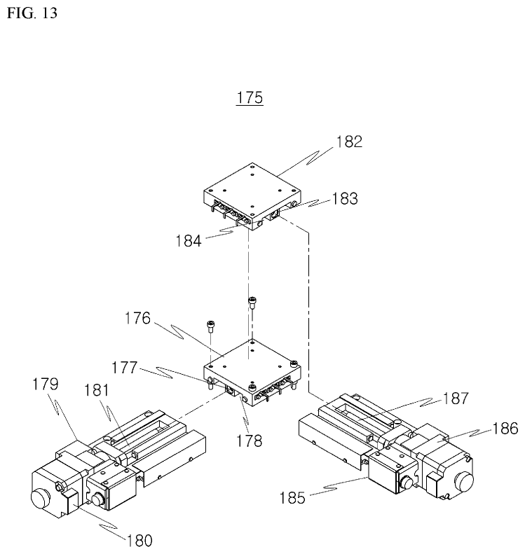

FIG. 12 is a three-dimensional view showing a slider unit of the cell supply device for a secondary battery according to the exemplary embodiment of the present invention, and FIG. 13 is an exploded three-dimensional view showing the slider unit of the cell supply device for a secondary battery according to the exemplary embodiment of the present invention.

As shown in FIGS. 12 and 13, the first transport member 170 includes the cell transport tray 173 radially installed on an upper surface of the second turntable 171 so that the cells 113 transported from the cell supply member 130 may be stacked, and the slider unit 175 for adjusting the cell transport tray 173 so that the cells 113 may be placed on the cell transport tray 173 in a state of being aligned at a correct position.

The first transport member 170 temporarily stacks the cells 113 moved from the cell supply member 130, and the first transport member 170 serves as a temporary bridge for moving the cells 113 moved from the cell supply member 130 to the second transport member 190.

The second turntable 171 is installed to be rotated by a second rotational motor 172 above the base plate 110, and the cell transport tray 173 for stacking the cells 113 moved from the cell supply member 130 is installed above the base plate 110.

Eight cell transport trays 173 are radially installed in the same manner on the cell supply member 130 and the second transport member 190 in the second turntable 171.

The slider unit 175 for adjusting a position of the cell transport tray 173 is installed on the lower surface of the cell transport tray 173.

The slider unit 175 includes a first slider 179 and a second slider 185 to vertically and horizontally move the cell transport tray 173, a lower adjustment plate moved by the first slider 179, and an upper adjustment plate moved by the second slider 185.

A first sliding hole 177 to which the first slider 179 is coupled is formed in the lower adjustment plate 176, and a guide groove 184 is formed in each of both sides of the sliding hole 177 so that the lower adjustment plate 176 may be linearly moved by the first slider 179.

A first driving motor 180 is provided on the first slider 179, and a first transport shaft 181 rotated by the first driving motor 180 is installed.

In other words, the lower adjustment plate 176 is slid by the rotation of the first transport shaft 181 to move the cell transport tray 173.

In addition, a second sliding hole 183 to which a second transport shaft 187 of the second slider 185 is coupled is formed in the upper adjustment plate 182, and the guide groove 184 is formed in each of both sides of the second sliding hole 183 so that the upper adjustment plate 182 may be linearly moved.

A second driving motor 186 is provided on the second slider 185, and a second transport shaft 187 rotated by the second driving motor 186 is coupled to the second sliding hole 183.

Therefore, the lower adjustment plate 176 may be moved by the first slider 179 to move the cell transport tray 173, and the upper adjustment plate 182 may be moved by the second slider 185 to move the cell transport tray 173.

Therefore, a position of the cell transport tray 173 may be freely adjusted according to the position of the cell 113.

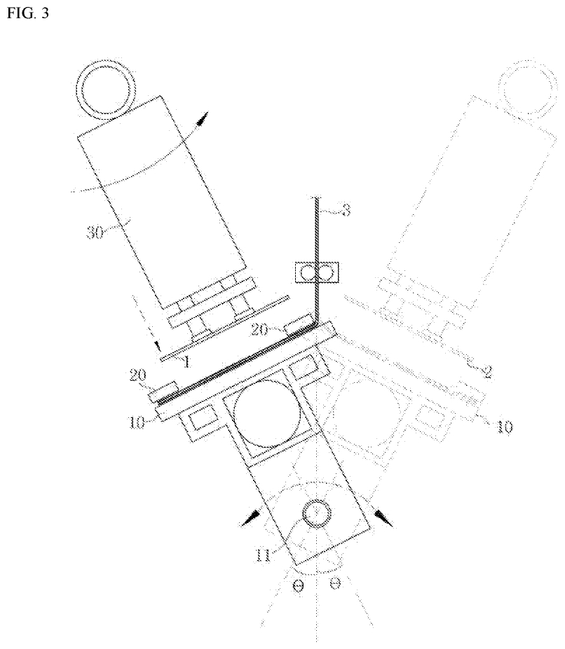

The cells 113 stacked on the cell transport tray 173 may be rotated toward the second transport member 190 by the second turntable 171, and the second transport member 190 may adsorb the cells 113 placed on the cell transport tray 173 and supply the cells 113 to the stack table 10 (see FIG. 3).

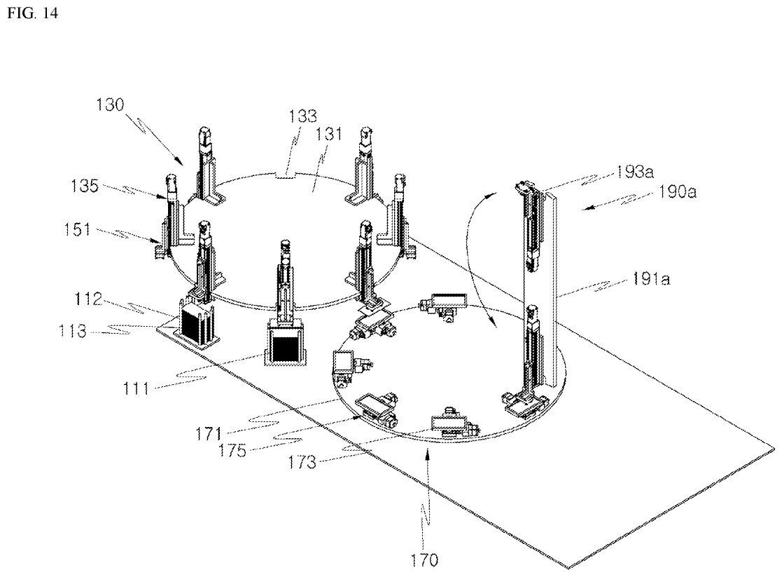

Meanwhile, FIG. 14 shows the second transport member 190 according to another embodiment of the present invention, and a third turntable 191a of the second transport member 190 is formed in a linear shape. In other words, since two upper and lower cell elevating units 135 and the cell adsorption unit 151 are installed on the third turntable 191a, it is possible to secure a space in which a separator (not shown) may be supplied.

In this case, it goes without saying that the third turntable 191a is rotated at a faster speed than the second turntable 171 to move the cells 113 placed on the second turntable 171.

As described above, by using a cell supply device for a secondary battery according to the present invention, cells of a positive electrode material and a negative electrode material can be alternately adsorbed and continuously moved by three turntables, and the cells are moved by a plurality of cell elevating units and cell adsorption units radially installed on the turntable, and thus it is possible to dramatically reduce a cell moving time, i.e., work time, and more quickly move the cells, thereby improving the productivity of the secondary battery.

Although the present invention implemented by the present inventors has been specifically described above according to embodiments, it goes without saying that the present invention is not limited to the embodiments and can be changed variously without departing from the gist of the present invention.

1. A cell supply device for a secondary battery, comprising:
a base plate (110) on which a positive electrode material tray (111) on which a positive electrode material is stacked and a negative electrode material tray (121) on which a negative electrode material is stacked are installed;
a cell supply member (130) on which a first turntable (131) installed to rotate horizontally at one side of the base plate (110), a cell elevating unit (135) installed on an upper surface of the first turntable (131) to move up and down so that cells (113) stacked on the positive electrode material tray (111) and the negative electrode material tray (112) are adsorbed, and a cell adsorption unit (151) configured to adsorb the cells (113) stacked on the positive electrode material tray (111) and the negative electrode material tray (112) by upward and downward movements of the cell elevating unit (135) are installed;
a first transport unit (170) provided with a second turntable (171) installed on the base plate (110) to rotate horizontally in the same manner as the first turntable (131) of the cell supply member (130), a cell transport tray (173) on which the cells (113) moved from the second turntable (171) are stacked, and a slider unit (175) installed on a lower surface of the cell transport tray (173) to adjust a position of the cell transport tray (173); and
a second transport member (190) provided with a third turntable (191) installed to rotate in a direction perpendicular to the second turntable (171), and a cell elevating unit (135) and a cell adsorption unit (151) installed on the third turntable (191) to move the cells (113) stacked on the cell transport tray (173) of the first transport cell (170) to a stack table.

2. The cell supply device of claim 1, wherein the positive electrode material tray (111) on which the positive electrode material is stacked and the negative electrode material tray (112) on which the negative electrode material is stacked are installed to be spaced a predetermined distance from each other on the base plate (110),
the first turntable (131) is installed to rotate horizontally at a predetermined height of the base plate (110),
the second turntable (171) is installed to rotate horizontally at a predetermined height of the base plate (110), and
the third turntable (191) is installed to rotate in a direction perpendicular to the base plate (110) to move the cells (113) stacked on the cell transport tray (173) of the second turntable (171).

3. The cell supply device of claim 1, wherein a plurality of cell elevating units (135) are radially installed on the first turntable (131) of the cell supply member (130) and the third turntable (191) of the second transport member (190) so that the cell adsorption unit (151) configured to adsorb the cells (113) moves up and down, and
the cell adsorption unit (151) for adsorbing the cells (113) is installed on the cell elevating unit (135) to move up and down.

4. The cell supply device of claim 1, wherein in the cell elevating unit (135), an LM guide (136) and an LM cover (137) are provided, and a slider block (138) is installed inside the LM guide (136) and the LM cover (137) to be moved up and down by rotation of a motor (141) installed above the LM guide (136),
a slider cover (144) is installed on a front surface of the slider block (138), and a steel band (143) is elastically installed between the slider block (138) and the slider cover (144) to block introduction of foreign substance into the LM guide (136), and
in the cell adsorption unit (151), a vertical plate (152) is installed on a front surface of the slider cover (144), a horizontal plate (154) is installed on a lower surface of the vertical plate (152), a lower plate (155) is installed on a lower surface of the horizontal plate (154), and an adsorption port (157) is installed on a lower surface of the lower plate (155) to adsorb the cell (113).

5. The cell supply device of claim 1, wherein the first transport member (170) includes the cell transport tray (173) radially installed on an upper surface of the second turntable (171) so that the cells (113) transported from the cell supply member (130) are stacked, and the slider unit (175) configured to adjust the cell transport tray (173) so that the cells (113) are placed on the cell transport tray (173) in a state of being aligned at a correct position.
